(19) United States
(12) Patent Application Publication
(10) Pub. No.: US 2005/0083175 A1
(43) Pub. Date: Apr. 21, 2005

(54) Keyless entry receiver

(75) Inventor: Hideki Yanagimoto, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/964,228

(22) Filed: Oct. 12, 2004

(30) Foreign Application Priority Data
Oct. 15, 2003 (JP) 2003-355609

(51) Int. Cl. G05B 23/00

(52) U.S. Cl. 340/5.72; 307/10.5; 340/426.36; 340/442; 340/447; 340/5.64

(57) ABSTRACT

A keyless entry receiver for a vehicle having an ignition switch is provided. The keyless entry receiver includes a receiving unit that receives a remote control signal and an air pressure monitoring signal. The remote control signal is configured to control a door locking/unlocking and is supplied from a keyless entry transmitter. The air pressure monitoring signal is configured to monitor air pressure of a tire and is supplied from an air pressure detecting unit. The receiving unit receives the remote control signal and the air pressure monitoring signal at a different time frame in response to an on/off operation of the ignition switch.

### PRIORITY CLAIM

This application claims under 35 U.S.C. § 119 the benefit of the filing date of Mar. 15, 2004 of Japanese Application No. 2003-355609, the entire contents of which are incorporated herein by reference.

### BACKGROUND

1. Technical Field

The invention relates to a keyless entry receiver and more particularly, a keyless entry receiver for a keyless entry system allowing drivers to lock/unlock a vehicle door without using a mechanical engine key.

2. Related Art

FIG. 2 shows a keyless entry system having a conventional keyless entry receiver. A driver generally carries a mechanical engine key 4 that has a holding portion 4. The holding portion 4 includes a built-in transmitter 4b. The transmitter 4b includes multiple switches 400 such as a door locking switch, a door unlocking switch or a trunk opening switch and the like, a memory unit 401 for storing ID codes corresponding to the pressed switches 400, and a control unit 402 for reading the ID codes from the memory unit 401 according to the pressed switches 400. When a driver presses the switches 400, code signals corresponding to the pressed switches 400 are outputted to an oscillating unit 403 from the control unit 402.

The oscillating unit 403 includes a crystal oscillator 4032 having a frequency of 314.35 MHz in order to produce a carrier signal. The oscillating unit 403 converts the code signals into a frequency modulation signal serving as a modulation signal. The frequency modulation signal is transmitted from an antenna 404. The transmitter 4b comprises a battery 405 and a voltage control unit 406. By operating the switches 400, a power is supplied to a respective unit so that an electric wave is transmitted for a predetermined time.

A keyless entry receiver 5 comprises a receiving unit 5a and a control unit 5b. The receiving unit 5a is a super heterodyne receiving unit that comprises a first bandpass filter (BPF1) 501, a high frequency (RF) amplifier 502, a mixer 503, and a local oscillator 504. The first bandpass filter (BPF1) filters an electric wave received from an antenna 500

The local oscillator 504 has an oscillating frequency that is fixed by a crystal oscillator 5041. The crystal oscillator 5041 has a frequency of 313.895 MHz. A received electric wave signal is frequency-converted into an intermediate frequency signal by an oscillating signal of the local oscillator 504 via the mixer 503. Subsequently, the frequency-converted signal is inputted to a second bandpass filter (BPF2) 505 having a center frequency of 455 KHz. The second bandpass filter (BPF2) 505 passes a signal having an intermediate frequency (IF) of 455 KHz. After the IF signal is amplified by an IF amplifier 506, the amplified IF signal passes through a detector circuit 507, a phase shifter 508, a low pass filter (LPF) 509, and a waveform shaping circuit 510. As a result, a digitized code signal is demodulated.

The control unit 5b determines whether a receiving signal intensity is sufficient by using a receiving signal intensity detecting circuit (“RSSI circuit”) 511. Upon determination that the receiving signal intensity is sufficient, the control unit 5b outputs the code signals to a body computer 6 without any change. The body computer 6 determines the demodulated code and outputs a control signal corresponding to the code to a driving circuit of an electromagnetic actuator. More detailed descriptions regarding the conventional keyless entry receiver can be found in Japanese Unexamined Patent Application Publication No. 2000-008669.

Automotive vehicles have been improved to include various receivers mounted thereon. Receivers receive various automotive vehicle information. One example of such receivers is a receiver used for air pressure monitor devices. Air pressure monitor devices are capable of monitoring tire air pressure. Because various receivers are mounted on automotive vehicles, installation expenses increase and installation space is restricted. Furthermore, an interference between receivers frequently occur.

### SUMMARY

A keyless entry receiver for a vehicle having an ignition switch is provided. The keyless entry receiver includes a receiving unit that receives a remote control signal and an air pressure monitoring signal. The remote control signal is configured to control a door locking/unlocking and is supplied from a keyless entry transmitter. The air pressure monitoring signal is configured to monitor air pressure of a tire and is supplied from an air pressure detecting unit. The receiving unit receives the remote control signal and the air pressure monitoring signal at a different time frame.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a circuit diagram showing one embodiment of a keyless entry receiver; and

FIG. 2 is a circuit diagram showing a conventional keyless entry receiver.

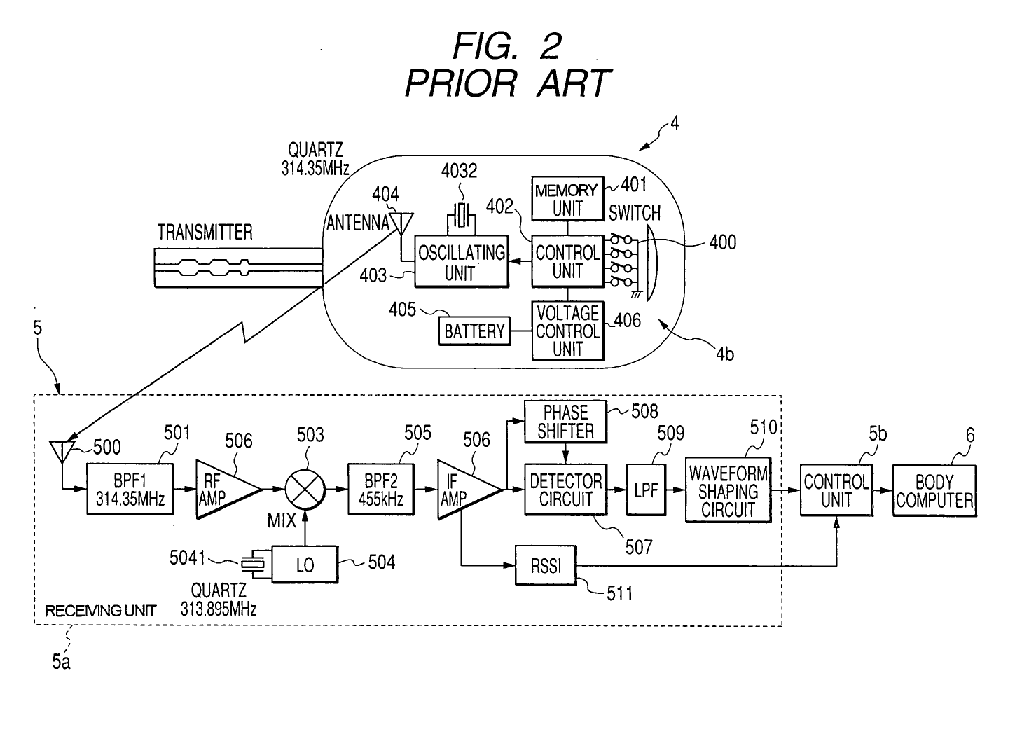

### DESCRIPTION OF THE PREFERRED EMBODIMENTS

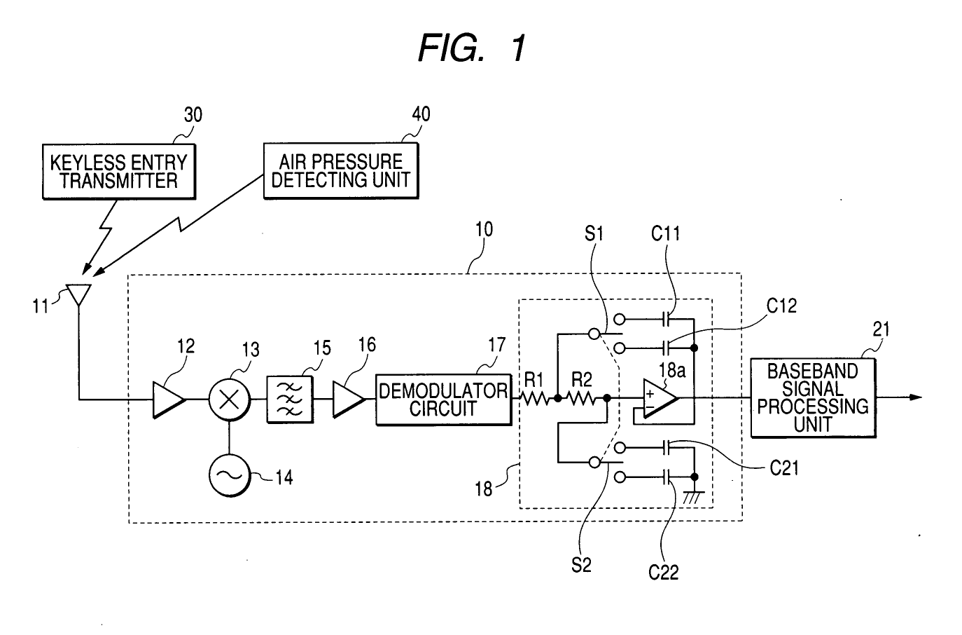

FIG. 1 shows one embodiment of a keyless entry receiver. An antenna 11 receives a remote control signal outputted from a keyless entry transmitter 30 and an air pressure monitoring signal outputted from an air pressure detecting unit 40. The keyless entry transmitter 30 is built in a holding portion of an engine key and the air pressure detecting unit 40 is installed on a tire (not shown). Both the remote control signal and the air pressure monitoring signal have a high frequency of approximately 315 MHz.

The remote control signal controls a door locking/unlocking and is modulated by a first digital signal. The modulation may be an amplitude shift keying (“ASK”) modulation. The air pressure monitoring signal is ASK-modulated by a second digital signal for representing an air pressure. A bit rate of the first digital signal and a bit rate of the second digital signal are 1 Kbps and 4 to 5 Kbps, respectively.

The remote control signal and the air pressure monitoring signal received by the antenna 11 are inputted to a high frequency amplifier 12 of a receiving unit 10. The receiving unit 10 also comprises a mixer 13, an oscillator 14, a bandpass filter 15, an intermediate frequency amplifier 16, a demodulator circuit 17, and a low pass filter 18. The remote control signal and the air pressure monitoring signal are amplified by the high frequency amplifier 12 and then the amplified signal is inputted to the mixer 13. Further, the amplified signal input to the mixer 13 is mixed with a local oscillating signal that is supplied to the mixer 13 from the oscillator 14. The mixed signal is frequency-converted into an intermediate frequency signal having a frequency of 10.7 MHz. The intermediate frequency signal is inputted to the intermediate frequency amplifier 16 via the bandpass filter 15 and then is inputted to the demodulator circuit 17.

The demodulator circuit 17 demodulates the remote control signal to extract the first digital signal and also demodulates the air pressure monitoring signal to extract the second digital signal. The first digital signal and the second digital signal become baseband signals. Each of the first digital signal and the second digital signal passes through the low pass filter 18, so that noise components of the first and the second digital signals are suppressed and a receiving sensitivity is increased. Each of the first digital signal and the second digital signal is inputted to the baseband signal processing unit 21 at a next stage. An actuator or an air pressure monitoring device receives the first or the second digital signals from the baseband signal processing unit 21 and performs a door locking/unlocking or a tire pressure monitoring.

Generally, in a keyless entry system, when an ignition switch is turned on by means of an engine key to start an engine, a keyless entry transmitter and a receiver for a door locking/unlocking does not work. However, a keyless entry receiver can receive the air pressure monitoring signal after the ignition switch is turned on.

Further, a bit rate of the first digital signal included in the remote control signal for a door locking/unlocking and a bit rate of the second digital signal contained in the air pressure monitoring signal are different from each other. Therefore, to improve a sensitivity of the digital signal after the demodulation is performed, a cutoff frequency of the low pass filter is changed corresponding to each bit rate.

The low pass filter 18 includes a secondary active low pass filter using, for example, an operation amplifier 18a, as shown in FIG. 1. Further, the low pass filter 18 is configured to change a frequency. In other words, the extracted digital signals are inputted to a non-inversion input terminal (+) of the operation amplifier 18a via two resistors R1 and R2 that are connected in series. An inversion input terminal (−) is connected to an output terminal. A connection point of the two resistors R1 and R2 is switched by a first switch S1 and is connected to the output terminal via a capacitor C11 or a capacitor C12. In addition, the non-inversion input terminal (+) is switched by a second switch S2 and is connected to a ground via a capacitor C21 or a capacitor C22.

Capacitance of the capacitor C12 is larger than that of the capacitor C11, and capacitance of the capacitor C22 is larger than that of the capacitor C21. The first and the second switches S1 and S2 are switched in conjunction with an on/off operation of the ignition switch. As the ignition switch is turned on by an engine key, an engine starts. In this case, the first switch S1 is switched to the capacitor C11 side and the second switch S2 is switched to the capacitor C21 side. As a result, the cutoff frequency increases up to approximately 9.5 KHz. The cutoff frequency is twice as large as that of the bit rate (4 to 5 Kbps) of the second digital signal by which the air pressure monitoring signal is modulated. Therefore, the second digital signal passes through the low pass filter 18 without being affected by the cutoff frequency. Consequently, noise components of a frequency region having a frequency higher than the cutoff frequency is suppressed, thereby improving a receiving sensitivity.

To the contrary, where the ignition switch is turned off by means of the engine key to stop an engine, the first switch S1 is switched to the capacitor C12 side and the second switch S2 is switched to the capacitor C22 side. As a result, the cutoff frequency decreases and becomes approximately 2 KHz. The cutoff frequency is twice as large as that of the bit rate (1 Kbps) of the first digital signal with which the remote control signal is modulated. Therefore, the first digital signal also passes through the low pass filter 18 without being affected by the cutoff frequency. Thus, noise components of a frequency region having a frequency higher than the cutoff frequency is suppressed, thereby improving a receiving sensitivity.

As described above, the cutoff frequency of the low pass filter is changed in conjunction with an on/off operation of the ignition switch by the engine key. Accordingly, the keyless entry receiver can be used in receiving the air pressure monitoring signal of the tire as well as the remote control signal for the door locking/unlocking.

As previously described, the keyless entry receiver includes a receiving unit for receiving a remote control signal and an air pressure monitoring signal. The remote control signal is outputted from a keyless entry transmitter so as to control a door locking/unlocking, and the air pressure monitoring signal is outputted from an air pressure detecting unit so as to monitor air pressure of the tire. The receiving unit is switched so as to receive the remote control signal when an ignition switch is turned off. Further, the receiving unit is switched so as to receive the air pressure monitoring signal when the ignition switch is turned on. Therefore, the keyless entry receiver can be used for the tire air pressure monitoring after the engine starts. Consequently, it is possible to increase efficiency of the keyless entry receiver.

In the keyless entry receiver, the remote control signal is modulated by a first digital signal, and the air pressure monitoring signal is modulated by the second digital signal that has a different bit rate from that of the first digital signal. The receiving unit includes a demodulator circuit which demodulates the remote control signal and the air pressure monitoring signal to extract the first digital signal and the second digital signal, respectively. A low pass filter passes through the extracted first and second digital signals. The cutoff frequency of the low pass filter is changed into a higher value or a lower value according to a size of a bit rate in conjunction with an on/off operation of the ignition switch. Therefore, noise components contained in the first digital signal and the second digital signal are substantially reduced and it is possible to prevent a receiving sensitivity of the signals from deteriorating.

Furthermore, a cutoff frequency of the low pass filter is larger than that of the bit rate by at least twice. It is possible to decrease noise components without distorting a waveform of digital signals that pass through the low pass filter. The low pass filter includes an active low pass filter using an operation amplifier and it is easy to set the cutoff frequency.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A keyless entry receiver for a vehicle having an ignition switch, comprising;
a receiving unit that receives a remote control signal and an air pressure monitoring signal, the remote control signal configured to control a door locking/unlocking and supplied from a keyless entry transmitter, and the air pressure monitoring signal configured to monitor an air pressure of a tire and supplied from an air pressure detecting unit,
wherein the receiving unit is switched to receive the remote control signal or the air pressure monitoring signal at a different time frame in response to an on/off operation of the ignition switch.

2. The keyless entry receiver according to claim 1, wherein the receiving unit receives the remote control signal when the ignition switch is turned off.

3. The keyless entry receiver according to claim 1, wherein the receiving unit receives the air pressure monitoring signal when the ignition switch is turned on.

4. The keyless entry receiver according to claim 2, wherein the receiving unit receives the air pressure monitoring signal when the ignition switch is turned on.

5. The keyless entry receiver according claim 1, wherein the remote control signal is modulated by a first digital signal.

6. The keyless entry receiver according to claim 5, wherein the air pressure monitoring signal is modulated by a second digital signal.

7. The keyless entry receiver according to claim 6, wherein the first digital signal has a different bit rate from that of the second digital signal.

8. The keyless entry receiver according to claim 6, wherein the receiving unit comprises a demodulator circuit that demodulates the remote control signal and the air pressure monitoring signal to extract the first digital signal and the second digital signal, respectively.

9. The keyless entry receiver according to claim 7, wherein the receiving unit further comprises a low pass filter through which the extracted first digital signal or the extracted second digital signals passes.

10. The keyless entry receiver according to claim 9, wherein a cutoff frequency of the low pass filter is changed into a higher value or a lower value according to a size of a bit rate of the first and the second digital signals.

11. The keyless entry receiver according to claim 10, wherein the cutoff frequency of the low pass filter is changed in response to an on/off operation of the ignition switch.

12. The keyless entry receiver according to claim 11, wherein the cutoff frequency of the low pass filter is changed to the higher value upon turning on of the ignition switch.

13. The keyless entry receiver according to claim 12, wherein the cutoff frequency of the low pass filter is at least twice as large as that of the bit rate of the second digital signal.

14. The keyless entry receiver according to claim 13, wherein the second digital signal passes through the low pass filter.

15. The keyless entry receiver according to claim 11, wherein the cutoff frequency of the low pass filter is changed to the lower value upon turning off of the ignition switch.

16. The keyless entry receiver according to claim 15, wherein the cutoff frequency of the low pass filter is at least twice as large as that of the bit rate of the first digital signal.

17. The keyless entry receiver according to claim 16, wherein the first digital signal passes through the low pass filter.

18. The keyless entry receiver according to claim 9, wherein the low pass filter includes an active low pass filter using an operation amplifier.

19. The keyless entry receiver according to claim 9, wherein the low pass filter includes a first switch, a second switch, a first capacitor, a second capacitor, a third capacitor and a fourth capacitor, and the first switch is switched between the first capacitor and the second capacitor, and the second switch is switched between the third capacitor and the fourth capacitor.

20. The keyless entry receiver according to claim 19, wherein the second capacitor has a larger capacitance than the first capacitor, and the fourth capacitor has a larger capacitance than the third capacitor.

21. The keyless entry receiver according to claim 20, wherein the first switch and the second switch are switched to the first capacitor and the third capacitor, respectively, upon the on operation of the ignition switch, so that a cutoff frequency of the low pass filter increases.

22. The keyless entry receiver according to claim 21, wherein the second digital signal passes through the low pass filter.

23. The keyless entry receiver according to claim 20, wherein the first switch and the second switch are switched to the second capacitor and the fourth capacitor, respectively, upon the off operation of the ignition switch, so that a cutoff frequency of the low pass filter decreases.

24. The keyless entry receiver according to claim 23, wherein the first digital signal passes through the low pass filter.

25. A method for operating a keyless entry receiver for a vehicle having an ignition switch, comprising:
transmitting a remote control signal from a keyless entry transmitter to a receiving unit, wherein the remote control signal is configured to control a door locking/unlocking;
transmitting an air pressure monitoring signal from an air pressure detecting unit to the receiving unit, wherein the air pressure monitoring signal is configured to monitor air pressure of a tire;
switching the receiving unit to receive the remote control signal upon an off operation of the ignition switch; and,
switching the receiving unit to receive the air pressure monitoring signal upon an on operation of the ignition switch.

26. The method according to claim 25, further comprising:
filtering by a low pass filter the remote control signal and the air pressure monitoring signal to extract a first digital signal and a second digital signal therefrom.

27. The method according to claim 26, further comprising:
changing a cutoff frequency of the low pass filter to a high frequency or a low frequency in response to an on/off operation of the ignition switch.

28. The method according to claim 26, further comprising:
changing a cutoff frequency of the low pass filter to a high frequency in response to the on operation of the ignition switch; and,
passing the second digital signal through the low pass filter.

29. The method according to claim 26, further comprising:
changing a cutoff frequency of the low pass filter to a low frequency in response to the off operation of the ignition switch; and,
passing the first digital signal through the low pass filter.
